(19) United States
(12) Patent Application Publication
(10) Pub. No.: US 2025/0347564 A1
(43) Pub. Date: Nov. 13, 2025

(54) BOLOMETER ARRAY, BOLOMETER ARRAY UNIT, AND LIGHT DETECTION METHOD

(71) Applicant: NEC Corporation, Tokyo (JP)

(72) Inventors: Tomo Tanaka, Tokyo (JP); Ryota Yuge, Tokyo (JP); Masahiko Sano, Tokyo (JP)

(73) Assignee: NEC Corporation, Tokyo (JP)

(21) Appl. No.: 19/204,715

(22) Filed: May 12, 2025

(30) Foreign Application Priority Data
May 13, 2024 (JP) 2024-078158

(51) Int. Cl. G01J 5/20; G01J 5/02

(52) U.S. Cl. CPC G01J 5/20; G01J 5/0205; G01J 5/026

(57) ABSTRACT

A bolometer array includes a plurality of bolometers and a substrate on which the bolometers are arranged side by side, each bolometer comprising a first electrode, a second electrode disposed on either side of the first electrode via an inter-electrode region, a semiconducting carbon nanotube film connected to the first electrode and the second electrode, and a third electrode disposed apart from the semiconducting carbon nanotube film and capable of adjusting the electric field applied to the semiconducting carbon nanotube film in accordance with the characteristics of the semiconducting carbon nanotube film.

### CROSS-REFERENCE TO RELATED APPLICATIONS

This application is based upon and claims the benefit of priority from Japanese patent application No. 2024-078158, filed on May 13, 2024, the disclosure of which is incorporated herein in its entirety by reference.

### TECHNICAL FIELD

The present disclosure relates to a bolometer array, a bolometer array unit, and a light detection method.

### BACKGROUND ART

It is widely known that bolometers are used to detect infrared rays.

For example, Japanese Unexamined Patent Application Publication No. 2023-174027 (Patent Document 1) discloses a bolometer type infrared detector having a carbon nanotube film containing semiconducting carbon tubes. Furthermore, Patent Document 1 also discloses that a plurality of elements can be arranged in an array to form a bolometer array.

In a bolometer having a semiconducting carbon nanotube film, the properties of the semiconducting carbon nanotube film change in a case where the film is doped with a substance such as a protective film.

In a bolometer array having a plurality of bolometers, the doping state of the semiconducting carbon nanotube film differs depending on the position of the bolometer. Such variations in the doping state cause variations in the carrier density of states, which in turn cause variations in the characteristics of the bolometer, such as the resistance value and the resistance temperature coefficient, which may hinder improvements in detection performance.

### SUMMARY

An example object of the present disclosure is to provide a bolometer array, a bolometer array unit, and a light detection method that solves the above-mentioned problems.

A bolometer array according to one example aspect of the present disclosure is provided with: a plurality of bolometers and a substrate on which the plurality of bolometers are arranged, wherein each of the bolometers comprises: a first electrode; a second electrode provided across an inter-electrode region from the first electrode; and a semiconducting carbon nanotube film connected to the first electrode and the second electrode; and a third electrode that is disposed apart from the semiconducting carbon nanotube film and that is capable of adjusting an electric field applied to the semiconducting carbon nanotube film in accordance with the characteristics of the semiconducting carbon nanotube film.

A bolometer array unit according to an example aspect of the present disclosure is provided with the bolometer array according to one example aspect of the present disclosure, and a control device capable of adjusting a voltage applied to the third electrode for each bolometer.

A light detection method according to one example embodiment of the present disclosure, wherein in a bolometer array comprising a first bolometer and a second bolometer as bolometers, each of which comprises: a first electrode; a second electrode provided across an inter-electrode region from the first electrode; and a semiconducting carbon nanotube film connected to the first electrode and the second electrode, the method adjusts the electric field applied to the semiconducting carbon nanotube film according to the characteristics of the semiconducting carbon nanotube film.

### BRIEF DESCRIPTION OF THE DRAWINGS

FIG. 1 is a schematic plan view showing an example of a bolometer array according to the present disclosure.

FIG. 2 is a schematic plan view showing an example of a bolometer included in the bolometer array according to the present disclosure.

FIG. 3 is a schematic cross-sectional view showing an example of a bolometer included in the bolometer array according to the present disclosure, taken along line AA of FIG. 2.

FIG. 4 is a schematic plan view including an inter-electrode region of the bolometer according to the present disclosure.

FIG. 5 is a flowchart illustrating an example of a method for manufacturing a bolometer array according to the present disclosure.

FIG. 6 is a schematic cross-sectional view showing an example of a bolometer array in the middle of being manufactured in Step S1 of the manufacturing method of the bolometer array according to the present disclosure.

FIG. 7 is a schematic cross-sectional view showing an example of a bolometer array in the middle of being manufactured in Step S2 of the manufacturing method of the bolometer array according to the present disclosure.

FIG. 8 is a schematic cross-sectional view showing an example of a bolometer array in the middle of being manufactured in Step S3 of the manufacturing method of the bolometer array according to the present disclosure.

FIG. 9 is a schematic cross-sectional view showing an example of a bolometer array in the middle of being manufactured in Step S4 of the manufacturing method of the bolometer array according to the present disclosure.

FIG. 10 is a schematic cross-sectional view showing an example of a bolometer array in the middle of being manufactured in Step S5 of the manufacturing method of the bolometer array according to the present disclosure.

FIG. 11 is a schematic cross-sectional view showing an example of a bolometer array in the middle of being manufactured in Step S6 of the manufacturing method of the bolometer array according to the present disclosure.

FIG. 12 is a schematic cross-sectional view showing an example of a bolometer array in the middle of being manufactured in Step S7 of the manufacturing method of the bolometer array according to the present disclosure.

FIG. 13 is a schematic cross-sectional view showing an example of a bolometer array in the middle of being manufactured in Step S8 of the manufacturing method of the bolometer array according to the present disclosure.

FIG. 14 is a schematic cross-sectional view showing an example of a bolometer array in the middle of being manufactured in Step S9 of the manufacturing method of the bolometer array according to the present disclosure.

FIG. 15 is a schematic cross-sectional view showing an example of a bolometer array in the middle of being manufactured in Step S10 of the manufacturing method of the bolometer array according to the present disclosure.

FIG. 16 is a schematic cross-sectional view showing an example of a bolometer array in the middle of being manufactured in Step S11 of the manufacturing method of the bolometer array according to the present disclosure.

FIG. 17 is a schematic cross-sectional view showing an example of a bolometer array in the middle of being manufactured in Step S12 of the manufacturing method of the bolometer array according to the present disclosure.

FIG. 18 is a schematic cross-sectional view showing an example of a bolometer array in the middle of being manufactured in Step S13 of the manufacturing method of the bolometer array according to the present disclosure.

FIG. 19 is a schematic diagram including a third electrode of a bolometer included in the bolometer array according to the present disclosure.

FIG. 20 is a schematic longitudinal sectional view including a third electrode of a modified example of a bolometer included in the bolometer array according to the present disclosure.

FIG. 21 is a schematic longitudinal sectional view including a third electrode of a modified example of a bolometer included in the bolometer array according to the present disclosure.

FIG. 22 is a schematic longitudinal sectional view including a third electrode of a modified example of a bolometer included in the bolometer array according to the present disclosure.

FIG. 23 is a schematic longitudinal sectional view including a third electrode of a modified example of a bolometer included in the bolometer array according to the present disclosure.

FIG. 24 is a schematic longitudinal sectional view including a third electrode of a modified example of a bolometer included in the bolometer array according to the present disclosure.

FIG. 25 is a schematic longitudinal sectional view including a third electrode of a modified example of a bolometer included in the bolometer array according to the present disclosure.

FIG. 26 is a schematic longitudinal sectional view including a third electrode of a modified example of a bolometer included in the bolometer array according to the present disclosure.

FIG. 27 is a schematic cross-sectional view including a third electrode of a modified example of a bolometer included in a bolometer array according to the present disclosure.

FIG. 28 is a schematic cross-sectional view including a third electrode of a modified example of a bolometer included in a bolometer array according to the present disclosure.

FIG. 29 is a schematic cross-sectional view including a third electrode of a modified example of a bolometer included in a bolometer array according to the present disclosure.

FIG. 30 is a schematic cross-sectional view including a third electrode of a modified example of a bolometer included in a bolometer array according to the present disclosure.

FIG. 31 is a schematic cross-sectional view including a third electrode of a modified example of a bolometer included in a bolometer array according to the present disclosure.

FIG. 32 is a schematic cross-sectional view including a third electrode of a modified example of a bolometer included in a bolometer array according to the present disclosure.

FIG. 33 is a schematic cross-sectional view showing a modified example of a bolometer included in the bolometer array according to the present disclosure.

FIG. 34 is a schematic cross-sectional view showing a modified example of a bolometer included in the bolometer array according to the present disclosure.

FIG. 35 is a schematic plan view showing an example of the bolometer array unit according to the present disclosure.

FIG. 36 is a schematic cross-sectional view showing an example of a bolometer array according to the present disclosure.

### EXAMPLE EMBODIMENT

Various example embodiments according to the present disclosure will be described below with reference to the drawings.

### First Example Embodiment

A first example embodiment of a bolometer array and a light detection method according to the present disclosure will be described below.

### (Bolometer Array)

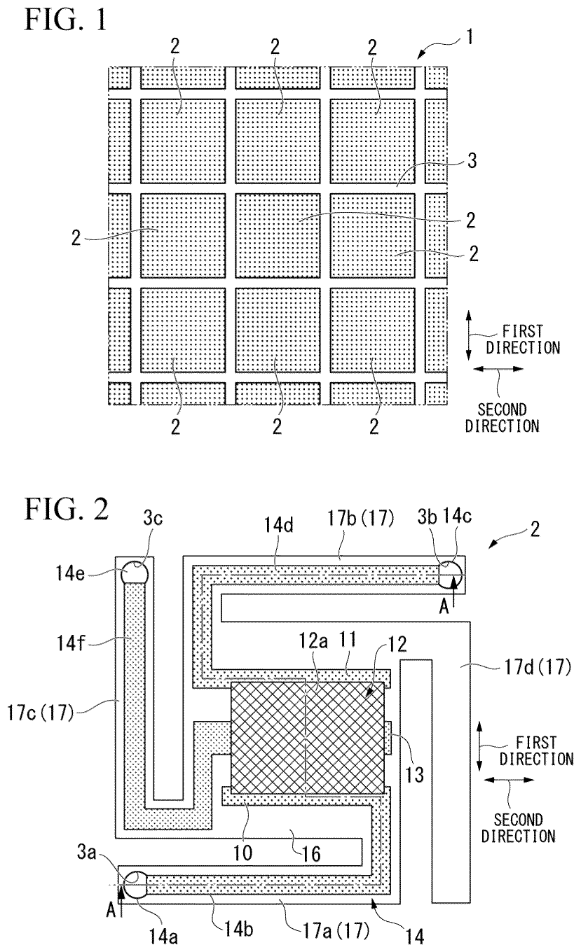

As shown in FIG. 1, the bolometer array 1 includes a plurality of bolometers 2 and a substrate 3.

The bolometer array 1 is a device for detecting infrared rays. The bolometer array 1 is applied to, for example, an uncooled infrared sensor.

Each bolometer 2 is an element that serves as a pixel of the bolometer array 1.

For example, the wavelength band of infrared light detected by the bolometer 2 may include 1 to 100 μm. Furthermore, for example, the wavelength band of infrared light detected by the bolometer 2 may include the terahertz band.

A plurality of bolometers 2 are provided on a substrate 3 and aligned in the plane.

For example, the substrate 3 may comprise an integrated readout circuit for reading out the change in electrical resistance from each bolometer 2.

Furthermore, the bolometer array 1 may include a sealing member that seals the area in which the multiple bolometers 2 are disposed so that the periphery of the multiple bolometers 2 is a vacuum.

The bolometers 2 are arranged along a first direction and a second direction in this disclosure. For example, the bolometers 2 are arranged at equal intervals in the first direction and the second direction.

The first direction and the second direction are directions within a plane in which the multiple bolometers 2 are arranged. The first direction and the second direction are perpendicular to each other.

The installation position of each bolometer 2 is not particularly limited. However, for convenience of explanation, a direction perpendicular to the first direction and the second direction is defined as the vertical direction (third direction).

Each bolometer 2 absorbs components contained in a detection band out of the wavelength band contained in the light to be detected, converts them into heat, and further outputs the temperature change due to the heat as an electrical signal. In other words, each bolometer 2 is an element that performs photoelectric conversion.

The lower limit of the element size of each bolometer 2 is determined by the limit size in the microfabrication process.

Moreover, the upper limit of the element size of each bolometer 2 is determined by the limit size for maintaining a hollow structure.

The size of such a bolometer 2 in each of the first and second directions is, for example, 10 μm to 50 μm.

### (Bolometer)

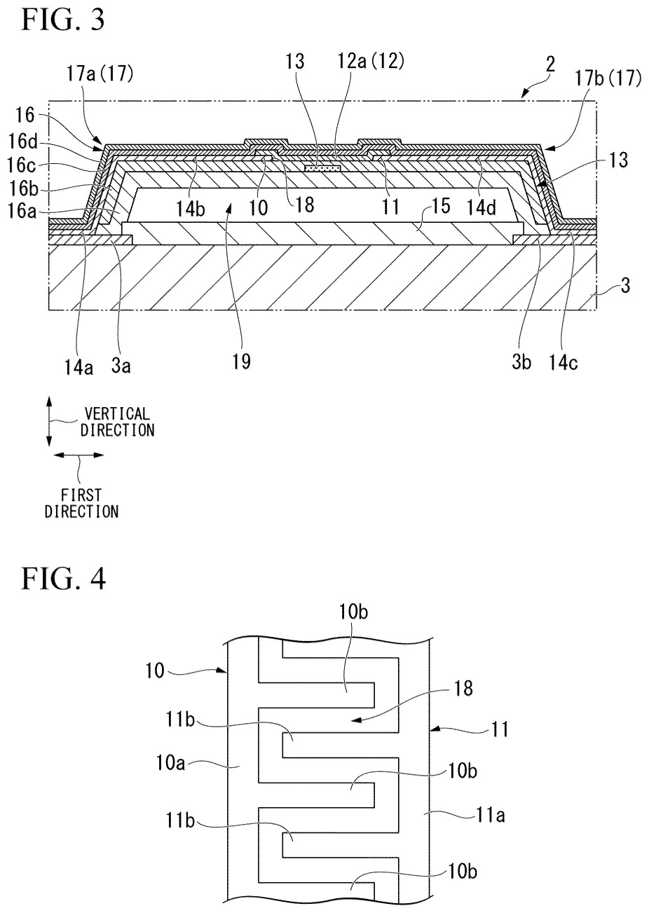

As shown in FIGS. 2 and 3, the bolometer 2 is disposed on the substrate 3. As shown in FIG. 3, the bolometer 2 is provided with a first electrode 10, a second electrode 11, a sensor portion 12, a third electrode 13, a wiring portion 14, an insulating film 15, and a protective film 16. As shown in FIG. 2, the bolometer 2 also has four support legs 17.

### (Configuration of First Electrode)

The first electrode 10 is an electrode for passing a current between the first electrode 10 and the second electrode 11 via the sensor portion 12.

As shown in FIG. 4, the first electrode 10 may include a first base end 10a and a plurality of first extension portions 10b. In a case where viewed from above, each of the multiple first extension portions 10b extends from the first base end 10a. These first extension portions 10b are formed to be parallel to each other.

FIG. 3 is a cross-sectional view of a portion where the first extension portion 10b is not provided.

The first electrode 10 is made of a conductive material such as aluminum, copper, gold, or TiAlV.

The size of the first extension portion 10b may be any size within an appropriate range in terms of compatibility between the possibility of fine processing and effectively reducing resistance. Furthermore, the number of the first extension portions 10b may be any number within an appropriate range in terms of compatibility between the possibility of fine processing and effectively reducing resistance.

For example, the width of each of the first extension portions 10b is 0.2 μm to 20 μm, and preferably 0.2 μm to 1 μm.

For example, the length of each of the first extension portions 10b is 20% to 99% of the element size of the bolometer 2, and preferably 30% to 70%.

For example, the number of the first extension portions 10b is 2 to 30, and preferably 5 to 15.

### (Configuration of Second Electrode)

The second electrode 11 is an electrode for passing a current between the first electrode 10 and the second electrode 11 via the sensor portion 12.

As shown in FIG. 4, the second electrode 11 may include a second base end 11a and a plurality of second extension portions 11b. In a case where viewed from above, each of the multiple second extension portions 11b extends from the second base end 11a. These second extension portions 11b are formed to be parallel to each other. These second extension portions 11b are formed to be parallel to each other.

FIG. 3 is a cross-sectional view of a portion where the second extension portion 11b is not provided.

The second electrode 11 is made of a conductive material such as aluminum, copper, gold, or TiAlV.

The size of the second extension portion 11b may be any size within an appropriate range in terms of compatibility between the possibility of fine processing and effectively reducing resistance. Furthermore, the number of the second extension portions 11b may be any number within an appropriate range in terms of compatibility between the possibility of fine processing and effectively reducing resistance.

For example, the width of each of the second extension portions 11b is 0.2 μm to 20 μm, and preferably 0.2 μm to 1 μm.

For example, the length of each of the second extension portions 11b is 20% to 99% of the element size of the bolometer 2, and preferably 30% to 70%.

For example, the number of the second extension portions 11b is 2 to 30, and preferably 5 to 15.

### (Inter-Electrode Area)

As shown in FIG. 4, the first extension portion 10b of the first electrode 10 is disposed between two second extension portions 11b of the second electrode 11. In addition, the second extension portion 11b of the second electrode 11 is disposed between the two first extension portions 10b of the first electrode 10. In other words, the first electrode 10 and the second electrode 11 have a structure in which the plurality of first extension portions 10b and the plurality of second extension portions 11b are interlocked as a whole.

The first extension portion 10b is disposed with a gap between the second extension portions 11b and the second base end 11a.

Further, the second extension portion 11b is disposed with a gap between the first extension portions 10b and the first base end 10a.

As a result, a meandering interelectrode region 18 is formed between the first electrode 10 and the second electrode 11 in a case where viewed from above.

In the present disclosure, the term “meandering” refers to a wavy shape. This includes stretching in an undulating manner.

For example, the inter-electrode region 18 extends in the second direction while repeatedly bending from one side in the first direction to the other side and then bending from the other side in the first direction to the one side.

For example, the width of the interelectrode region 18 may be not less than 500 nm and not more than 3 μm.

In the present disclosure, the “width of the interelectrode region 18” refers to the length of the interelectrode region 18 in the electrode opposing direction between the first electrode 10 and the second electrode 11.

### (Configuration of Sensor Portion)

The sensor portion 12 receives infrared rays and detects an amount related to the intensity of the received infrared rays as an amount of change in electrical resistance value.

The sensor portion 12 has a function of converting the received infrared rays into heat and changing the electrical resistance value between the first electrode 10 and the second electrode 11 in relation to the converted heat.

The sensor portion 12 is provided with a carbon nanotube film 12a. The sensor portion 12 may also include a light receiving portion 12b and a connection portion 12c, which will be described later.

### (Configuration of Carbon Nanotube Film)

The carbon nanotube film 12a functions as an electrical resistor whose electrical resistance value changes in relation to heat.

The carbon nanotube film 12a (semiconducting carbon nanotube film) is electrically connected to the first electrode 10 and the second electrode 11 in the inter-electrode region 18.

The carbon nanotube film 12a is electrically connected to the first electrode 10 and the second electrode 11 over the inter-electrode region 18 so as to extend along the inter-electrode region 18.

For example, the carbon nanotube film 12a may be filled over the entire inter-electrode region 18 so as to extend in a meandering manner through the inter-electrode region 18.

For example, the thickness of the carbon nanotube film 12a may be preferably 0.7 nm or more and 50 nm or less, more preferably 0.7 nm or more and 10 nm or less, and further preferably 0.7 nm or more and 5 nm or less.

The carbon nanotube film 12a contains semiconducting carbon nanotubes.

For example, the carbon nanotube film 12a may preferably contain 80% or more semiconducting carbon nanotubes, more preferably 90% or more semiconducting carbon nanotubes, and even more preferably 95% or more. At 95% or more, further improvement in characteristics is expected. On the other hand, in the range of 90% to less than 95%, it is possible to expect improved characteristics while reducing process costs.

For example, the carbon nanotube film 12a may contain semiconducting carbon nanotubes extracted by the electric-field-induced layer formation (ELF) method. The carbon nanotube film 12a may contain semiconducting carbon nanotubes extracted by other techniques, but preferably contains semiconducting carbon nanotubes extracted by the ELF method. In this case, for example, from the viewpoint of preventing adverse effects on the electrical characteristics of the bolometer 2, a non-ionic surfactant may be used in the ELF method for extracting the semiconducting carbon nanotubes.

For example, the length of one of the semiconducting carbon nanotubes separated by the ELF method may be 10 nm to 1 μm.

For example, in the carbon nanotube film 12a, the semiconducting carbon nanotubes may be bundled. In this case, the length of the bundle may be about 100 nm to 10 μm.

For example, the carbon nanotube film 12a may include a carbon nanotube network film in which a plurality of carbon nanotubes are randomly oriented to form a network with each other.

In the present disclosure, the term “carbon nanotube network film” refers to a carbon nanotube film in which a plurality of carbon nanotubes are randomly oriented to form a network with each other.

The carbon nanotube film 12a is covered from above with the protective film 16. The carbon nanotube film 12a, by being doped with a substance from the protective film 16, undergoes changes in properties such as the resistance value and the temperature coefficient of resistance (TCR).

The doping state of the carbon nanotube film 12a varies depending on the position of the bolometer 2 on the substrate 3.

Therefore, the characteristics of such carbon nanotube film 12a differ depending on the position of bolometer 2 on the substrate 3.

### (Configuration of Third Electrode)

The third electrode 13 is an electrode for adjusting the electric field applied to the carbon nanotube film 12a.

As shown in FIG. 3, in the present example embodiment, the third electrode 13 is disposed below the carbon nanotube film 12a. That is, in this example embodiment, the third electrode 13 is disposed so as to overlap the carbon nanotube film 12a in a case where viewed from above (the third direction).

The third electrode is made of a conductive material such as aluminum, copper, gold, or TiAlV.

The third electrode 13 is enclosed in the protective film 16.

In the present example embodiment, as described below, the protective film 16 includes a first lower protective film 16a, a second lower protective film 16b, a first upper protective film 16c, and a second upper protective film 16d.

The third electrode 13 is provided on the first lower protective film 16a and is covered from above with the second lower protective film 16b. That is, in the present example embodiment, the third electrode 13 is located between the first lower protective film 16a and the second lower protective film 16b.

The third electrode 13 is formed in a plate shape with its front and back sides facing up and down, and is disposed apart from the carbon nanotube film 12a without being in direct contact with it.

The third electrode is insulated from the carbon nanotube film 12a by sandwiching the protective film 16 therebetween.

The third electrode 13 is connected to a control device 102 (described later) via a wiring portion 14, and a voltage is applied thereto under the control of the control device 102.

In a case where a voltage is applied to the third electrode 13, the third electrode 13 forms an electric field having an electric field strength according to the voltage. In other words, the third electrode 13 adjusts the electric field applied to the carbon nanotube film 12a. In a case where the electric field strength applied to the carbon nanotube film 12a is changed, the characteristics of the carbon nanotube film 12a can be changed.

In other words, by adjusting the electric field applied to the carbon nanotube film 12a, the resistance value and the temperature coefficient of resistance of the carbon nanotube film 12a can be adjusted.

For example, the voltage applied to the third electrode 13 of each bolometer 2 can be adjusted individually, and variations in the characteristics of the carbon nanotube film 12a can be suppressed.

### (Configuration of Wiring Portion)

As shown in FIG. 3, the wiring portion 14 includes a first contact portion 14a, a first wiring 14b, a second contact portion 14c, and a second wiring 14d. As shown in FIG. 2, the wiring portion 14 includes a third contact portion 14e and a third wiring 14f.

The first contact portion 14a, the first wiring 14b, and the first electrode 10 may be an integral thin film.

Similarly, the second contact portion 14c, the second wiring 14d, and the second electrode 11 may be integral with each other as a thin film.

Similarly, the third contact portion 14e, the third wiring 14c, and the third electrode 13 may be integral with each other as a thin film.

The wiring portion 14 is made of a conductive material such as aluminum, copper, gold, or TiAlV.

The first contact portion 14a is connected to a pad 3b of the substrate 3. The first contact portion 14a is disposed below the first electrode 10, the second electrode 11, and the carbon nanotube film 12a.

The first wiring 14b extends so as to connect the first electrode 10 and the first contact portion 14a.

One end of the first wiring 14b is connected to the first base end 10a of the first electrode 10. The other end of the first wiring 14d is connected to the first contact portion 14a.

The first wiring 14b slopes so as to head upward as it extends from the other end to the one end.

The second contact portion 14c is connected to a pad 3b of the substrate 3. The second contact portion 14c is disposed below the first electrode 10, the second electrode 11, and the carbon nanotube film 12a.

The second wiring 14d extends so as to connect the second electrode 11 and the second contact portion 14c.

One end of the second wiring 14d is connected to the second base end 11a of the second electrode 11. The other end of the second wiring 14d is connected to the second contact portion 14c.

The second wiring 14d slopes so as to head upward as it extends from the other end to the one end.

The third contact portion 14e is connected to the pad 3c of the substrate 3 as shown in FIG. 2. The third contact portion 14e is disposed below the first electrode 10, the second electrode 11, and the carbon nanotube film 12a.

The third wiring 14f extends so as to connect the third electrode 13 and the third contact portion 14e. One end of the third wiring 14f is connected to the edge of the third electrode 13. The other end of the third wiring 14f is connected to the third contact portion 14e.

The third wiring 14f slopes so as to head upward as it extends from the other end to the one end.

### (Configuration of Insulating Film)

The insulating film 15 is formed to cover the upper surface of the substrate 3.

The insulating film 15 has openings that expose the pads 3a, 3b and 3c.

### (Configuration of Protective Film)

The protective film 16 covers the carbon nanotube film 12a, the first electrode 10, the second electrode 11, the third electrode 13 and the wiring portion 14 in an integrated manner.

The protective film 16 is a thin film made of an insulating material such as silicon nitride, silicon oxide, or resin.

In addition, the protective film 16 may include a first lower protective film 16a and a second lower protective film 16b located below the carbon nanotube film 12a, the first electrode 10, the second electrode 11 and the wiring portion 14.

In addition, the protective film 16 may include a lower protective film consisting of one layer below the carbon nanotube film 12a, the first electrode 10, the second electrode 11, and the wiring portion 14.

The protective film 16 includes a first upper protective film 16c and a second upper protective film 16d located above the carbon nanotube film 12a, the first electrode 10, the second electrode 11, and the wiring portion 14.

In addition, the protective film 16 may include an upper protective film consisting of one layer located above carbon nanotube film 12a, the first electrode 10, the second electrode 11, and the wiring portion 14.

The first lower protective film 16a is located below the second lower protective film 16b. A cavity 19 is located below the first lower protective film 16a. The lower surface of the first lower protective film 16a forms the ceiling surface of the cavity 19.

The second lower protective film 16b is formed on the first lower protective film 16a and is in contact with the lower surfaces of the carbon nanotube film 12a, the first electrode 10, the second electrode 11, and the wiring portion 14.

In addition, the third electrode 13 is disposed between the first lower protective film 16a and the second lower protective film 16b.

The first upper protective film 16c is located below the second upper protective film 16d. The first upper protective film 16c is in contact with the top surfaces of carbon nanotube film 12a, the first electrode 10, the second electrode 11, and the wiring portion 14.

The second upper protective film 16d is formed on the first upper protective film 16c. The second upper protective film 16d is in contact with the lower portion of the connection portion 12c of the sensor portion 12 from above.

The support legs 17 support the first electrode 10, the second electrode 11, the third electrode 13 and the sensor portion 12 in the air so that the first electrode 10, the second electrode 11, the third electrode 13 and the sensor portion 12 are separated from the substrate 3. As shown in FIG. 3, the cavity 19 is formed between the first electrode 10, the second electrode 11, the third electrode 13 and the sensor portion 12.

The support legs 17 are formed using, for example, a part of the protective film 16.

The bolometer 2 may include, as the support legs 17, a first support leg 17a, a second support leg 17b, and a third support leg 17c.

For example, the first support leg 17a includes the first wiring 14b therein. The first wiring 14b can also function as a structural component for the first support leg 17a.

For example, the second support leg 17b includes the second wiring 14d therein. The second wiring 14d can also function as a structural component for the second support leg 17b.

For example, the third support leg 17c includes the third wiring 14f therein. The third wiring 14f can also function as a structural component for the third support leg 17c.

In the present example embodiment, the fourth support leg 17d does not include any wiring. The fourth support leg 17d may contain a structural component. By providing the fourth support leg 17d, the shape of the bolometer 2 viewed from above becomes closer to a symmetrical shape with respect to the center of the bolometer 2, and the supporting attitude of the bolometer 2 becomes stable.

In a case where viewed from above, the first support leg 17a and the second support leg 17b are arranged in the first direction with the carbon nanotube film 12a sandwiched therebetween.

Also, in a case where viewed from above, the third support leg 17c and the fourth support leg 17d are arranged in the second direction with the carbon nanotube film 12a sandwiched therebetween.

Therefore, as shown in FIG. 2, the carbon nanotube film 12a is supported from four directions by the four support legs 17.

### (Method of Manufacturing Bolometer Array)

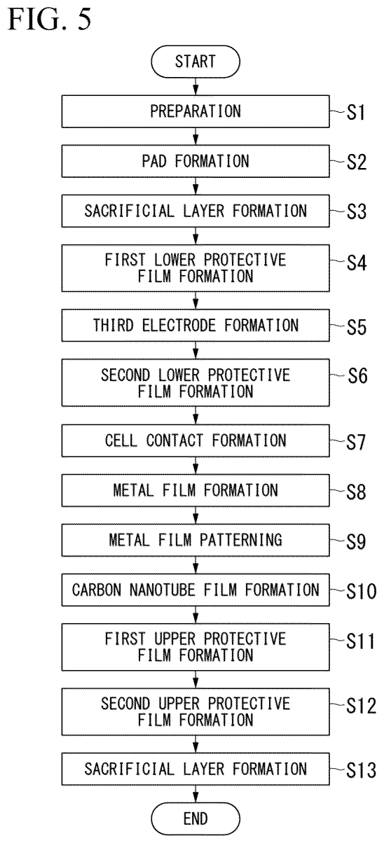

As shown in FIG. 5, the method of manufacturing the bolometer array 1 includes, for example, steps S1 to S13.

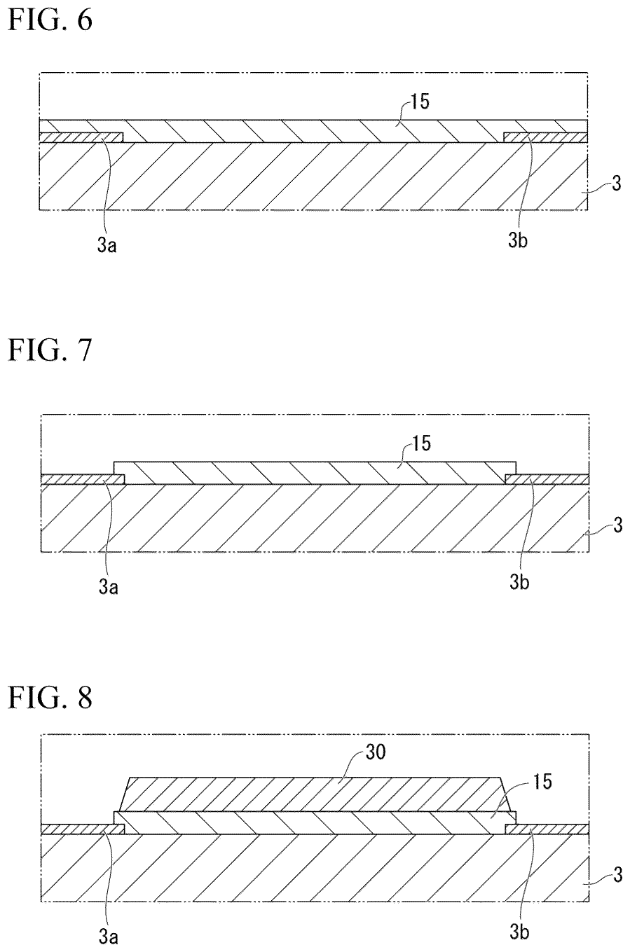

First, as shown in FIG. 6, the manufacturer prepares the substrate 3 on which a metal layer is provided to become the pads 3a, 3b, and 3c, and on which the surface is covered with an insulating film 15 (Step S1).

Following the execution of Step S1, the manufacturer forms the pads 3a and 3b on the substrate 3 as shown in FIG. 7 (Step S2). The manufacturer also forms the pad 3c in the same manner as pads 3a and 3b. The manufacturer forms openings in parts of the insulating film 15 to expose the metal layer that will become the pads 3a and 3b.

Following the execution of Step S2, the manufacturer forms a sacrificial layer 30 on the insulating film 15 as shown in FIG. 8 (Step S3). The first sacrificial layer 30 is a layer that is removed in a later process to form the cavity 19. The sacrificial layer 30 is formed of, for example, an organic polyimide.

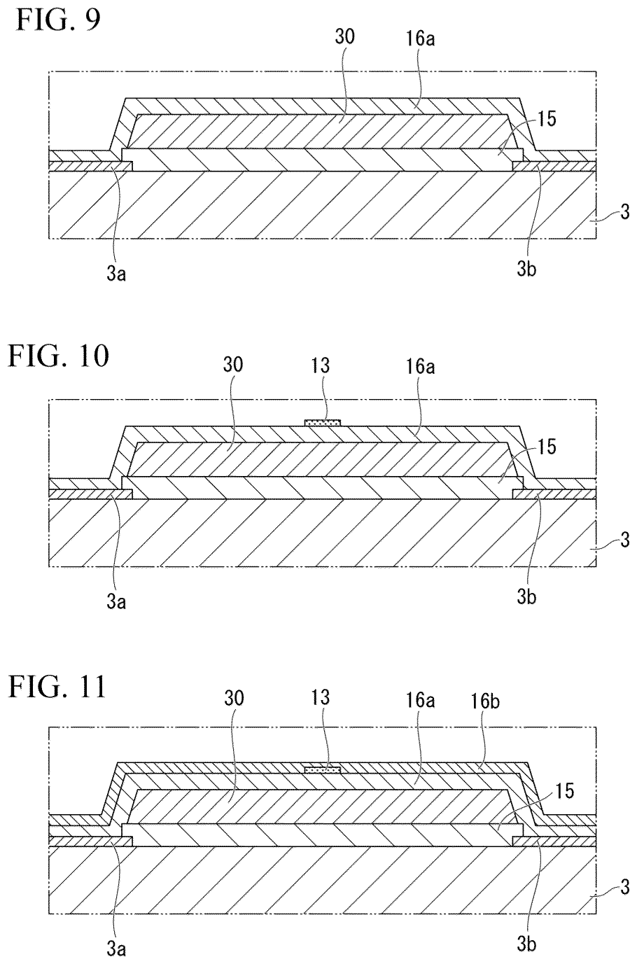

Following the execution of Step S3, the manufacturer forms a first lower protective film 16a on the sacrificial layer 30 as shown in FIG. 9 (Step S4).

Following the execution of Step S4, the manufacturer forms the third electrode 13 on the first lower protective film 16a, as shown in FIG. 10 (Step S5). Furthermore, the manufacturer forms the third electrode 13 as well as the third contact portion 14e and the third wiring 14f. For example, the manufacturer forms a metal film that becomes the third electrode 13, the third contact portion 14e, and the third wiring 14f, and patterns the metal film to form the third electrode 13, the third contact portion 14e, and the third wiring 14f. For example, the third electrode 13, the third contact portion 14e, and the third wiring 14f are made of a conductive material such as copper, gold, or TiAlV.

Following the execution of Step S5, the manufacturer forms the second lower protective film 16b on the first lower protective film 16a, as shown in FIG. 11 (Step S6).

The manufacturer forms the second lower protective film 16b so as to cover from above the third electrode 13 and the like formed in Step S4.

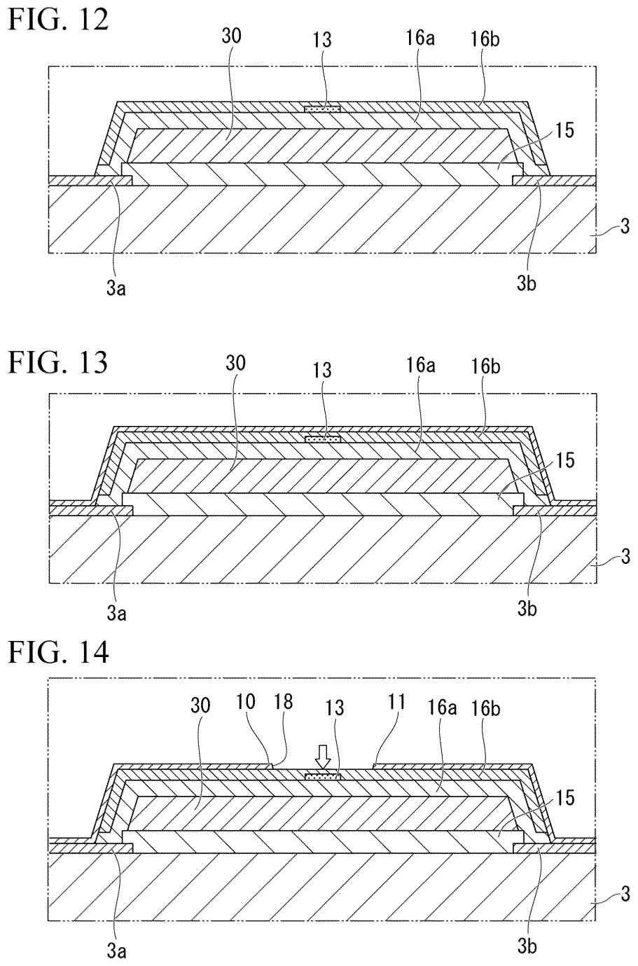

Following execution of Step S6, the manufacturer forms openings (cell contacts) exposing the pads 3a and 3b in the first lower protective film 16a and the second lower protective film 16b as shown in FIG. 12 (Step S7). The manufacturer also forms openings (cell contacts) in the first lower protective film 16a and the second lower protective film 16b to expose the pad 3c.

Following the execution of Step S7, the manufacturer forms the metal film 31 as shown in FIG. 13 (Step S8). The metal film 31 is a thin metal film for forming the first electrode 10, the second electrode 11, the first contact portion 14a, the first wiring 14b, the second contact portion 14c, and the second wiring 14d. For example, the metal film 31 is made of a conductive material such as copper, gold, or TiAlV.

Following the execution of Step S8, the manufacturer performs patterning of the metal film 31 as shown in FIG. 14 (Step S9). For example, as shown in FIG. 14, the metal film 31 is patterned to remove the portions indicated by the arrows. The first electrode 10, the second electrode 11 and the wiring portion 14 are formed by patterning the metal film 31. The metal film 31 is patterned to form, for example, the meandering inter-electrode region 18.

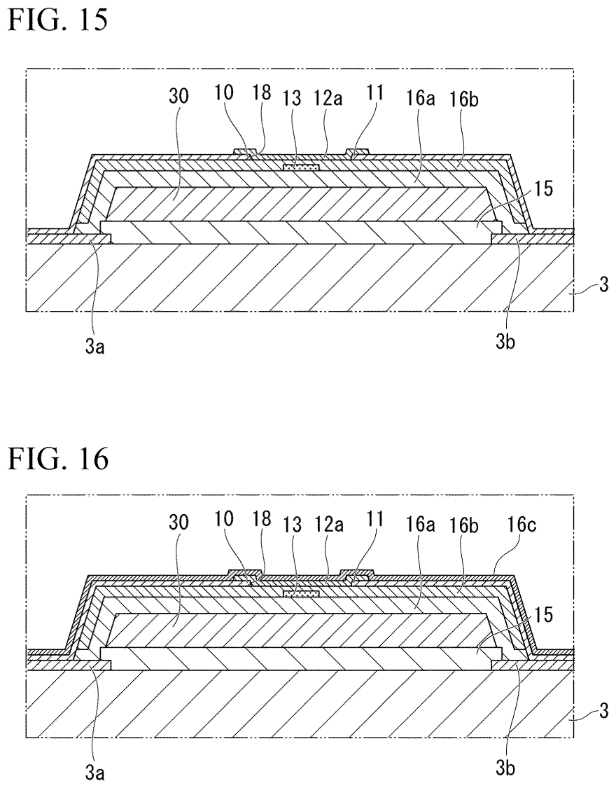

Following the execution of Step S9, the manufacturer forms the carbon nanotube film 12a as shown in FIG. 15 (Step S9).

The carbon nanotube film 12a is formed at least in the inter-electrode region 18.

Following the execution of Step S10, the manufacturer forms the first upper protective film 16c as shown in FIG. 16 (Step S11).

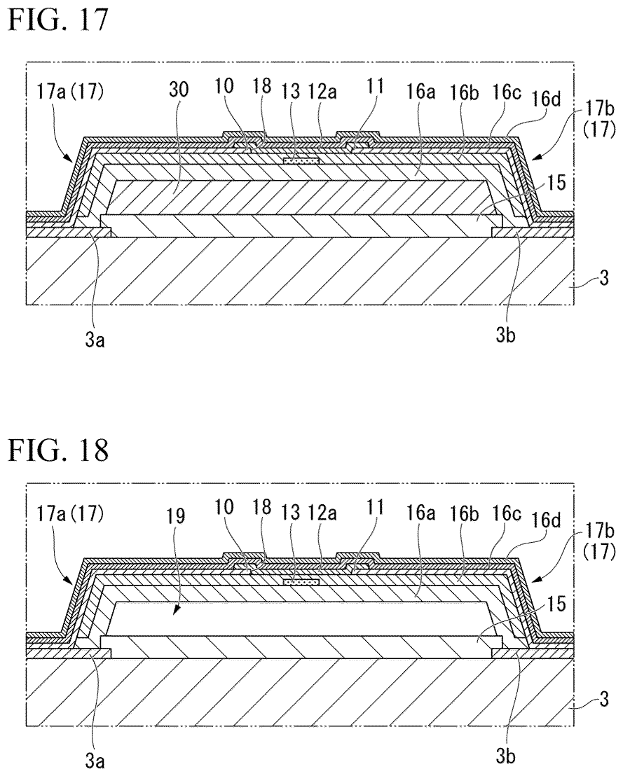

Following the execution of Step S11, the manufacturer forms the second upper protective film 16d as shown in FIG. 17 (Step S12).

Following the execution of Step S12, the manufacturer removes the sacrificial layer 30 as shown in FIG. 18 (Step S13). For example, the sacrificial layer 30 may be removed using oxygen plasma. By removing the sacrificial layer 30, the bolometer array 1 having the cavity 19 is produced.

### (Bolometer Array Operation)

The operation of the bolometer array 1 of the present example embodiment will be described.

In a case where light to be detected is incident on the bolometer array 1, each of the bolometers 2 converts the light to be detected into heat.

The generated heat warms the carbon nanotube film 12a.

In a case where the carbon nanotube film 12a is heated, the electrical resistance value of the carbon nanotube film 12a changes.

The bolometer 2 electrically detects the change in the electrical resistance value of the carbon nanotube film 12a in the inter-electrode region 18 by passing a current between the first electrode 10 and the second electrode 11, and outputs the detection result.

Moreover, in the bolometer array 1 of the present example embodiment, a voltage is applied to the third electrode 13 so that the characteristics of the bolometer 2 approach predetermined reference characteristics.

In a case where the voltage applied to the third electrode 13 is changed, there is a correlation between the change in the resistance value, which is one of the characteristics of the bolometer 2, and the change in the resistance temperature change coefficient, which is also one of the characteristics of the bolometer 2. Therefore, by adjusting the voltage applied to the third electrode 13, the resistance value and the resistance temperature change coefficient can be adjusted.

In a case where a plurality of the bolometers 2 are provided, the characteristics of each bolometer 2 (that is, the carbon nanotube film 12a) are different as described above. In other words, the characteristics of the bolometers 2 differ for each bolometer 2 with respect to preset reference characteristics (reference values of the resistance value and the resistance temperature coefficient of change).

In the present example embodiment, a voltage is applied to the third electrode 13 such that the resistance value and the resistance temperature coefficient become reference values according to the bolometer 2 in which the third electrode 13 is provided.

That is, in the present example embodiment, the voltage applied to the third electrode 13 of each bolometer 2 is set in accordance with the characteristics of the bolometer 2.

A voltage is applied to the third electrode such that the resistance value and the resistance temperature coefficient become reference values, and the characteristics of each bolometer 2 are adjusted to the reference characteristics.

Therefore, the detection results output from each bolometer 2 are less affected by variations in the characteristics of each bolometer 2.

In this manner, the light detection method using the bolometer array 1 of the present example embodiment adjusts the electric field applied to the carbon nanotube film 12a in accordance with the characteristics of the carbon nanotube film 12a.

Therefore, the detection results obtained by the light detection method using the bolometer array 1 of the present example embodiment are less affected by the variations in the characteristics of the individual bolometers 2.

### (Action and Effects)

The bolometer array 1 of the present example embodiment is provided with a plurality of the bolometers 2 and the substrate 3 on which the plurality of bolometers 2 are arranged side by side. Each of the bolometers 2 is provided with the first electrode 10, the second electrode 11, the carbon nanotube film 12a, and the third electrode 13. The second electrode 11 is provided with an inter-electrode region 18 sandwiched between the first electrode 10 and the second electrode 11. The carbon nanotube film 12a is connected to the first electrode 10 and the second electrode 11. The third electrode 13 is disposed apart from the carbon nanotube film 12a. Furthermore, the third electrode 13 can adjust the electric field applied to the carbon nanotube film 12a in accordance with the characteristics of the carbon nanotube film 12a.

The electric field applied to the carbon nanotube film 12a changes depending on the voltage applied to the third electrode 13. Furthermore, the characteristics of the carbon nanotube film 12a, including the resistance value and the resistance temperature coefficient, change depending on the electric field applied to the carbon nanotube film 12a. Therefore, by changing the voltage applied to the third electrode 13, it is possible to adjust the characteristics of the carbon nanotube film 12a, including the resistance value and the resistance temperature coefficient.

Since the bolometer array 1 of the present example embodiment includes the third electrode 13 as described above, the characteristics of the carbon nanotube film 12a, including the resistance value and the resistance temperature coefficient, can be adjusted.

In a case where a plurality of the bolometers 2 are provided, the characteristics of each bolometer 2 (that is, the carbon nanotube film 12a) are different as described above.

The bolometer array 1 of the present example embodiment can suppress such variations in the characteristics of the bolometers 2 by using the third electrode 13.

Therefore, the bolometer array 1 of the present example embodiment can suppress the influence on the detection performance due to the variation in characteristics of the bolometers 2, such as the resistance value and the resistance temperature change coefficient.

Moreover, the light detection method of the present example embodiment uses the bolometer array 1 to be able to adjust the electric field applied to the carbon nanotube film 12a in accordance with the characteristics of the carbon nanotube film 12a.

Therefore, the light detection method of the present example embodiment can suppress the influence on detection performance due to the variation in characteristics such as the resistance value and the resistance temperature change coefficient of the bolometers 2.

Each bolometer 2 also has a support leg 17. Furthermore, the support legs 17 support the first electrode 10, the second electrode 11 and the carbon nanotube film 12a so that the cavity 19 is formed between the support legs 17 and the substrate 3. The bolometer 2 also has the support legs 17, which are the first support leg 17a that includes the first wiring 14b connected to the first electrode 10, the second support leg 17b that includes the second wiring 14d connected to the second electrode 11, and the third support leg 17c that includes the third wiring 14f connected to the third electrode 13.

In the bolometer array 1 and the light detection method of the present example embodiment, the carbon nanotube film 12a is supported by three or more support legs. Therefore, the bolometer array 1 and the light detection method of the present example embodiment can stably support the carbon nanotube film 12a.

Furthermore, each bolometer 2 includes, as the support leg 17, a fourth support leg 17d that does not include any wiring.

In the bolometer array 1 and the light detection method according to the present example embodiment, the carbon nanotube film 12a is supported by four or more support legs. Therefore, the bolometer array 1 and the light detection method of the present example embodiment can support the carbon nanotube film 12a more stably.

The bolometers 2 are arranged in the first direction and the second direction perpendicular to the first direction. In a case where viewed from above perpendicular to the first and second directions, the first support leg 17a and the second support leg 17b are arranged in the first direction with the carbon nanotube film 12a sandwiched therebetween. In a case where viewed from above, the third support leg 17c and the fourth support leg 17d are arranged in the second direction with the carbon nanotube film 12a sandwiched therebetween.

In the bolometer array 1 and the light detection method of the present example embodiment, the shape of the bolometer 2 viewed from above approaches a symmetrical shape with respect to the center of the bolometer 2. Therefore, the bolometer array 1 and the light detection method of the present example embodiment can stabilize the supporting posture of the carbon nanotube film 12a.

In a case where viewed from above, third electrode 13 is disposed so as to overlap at least a portion of carbon nanotube film 12a.

In the bolometer array 1 and light detection method of the present example embodiment, the third electrode 13 and the carbon nanotube film 12a are arranged so as to overlap each other, so that the shape of the bolometer 2 in a case where viewed from above can be made small.

### (Modification)

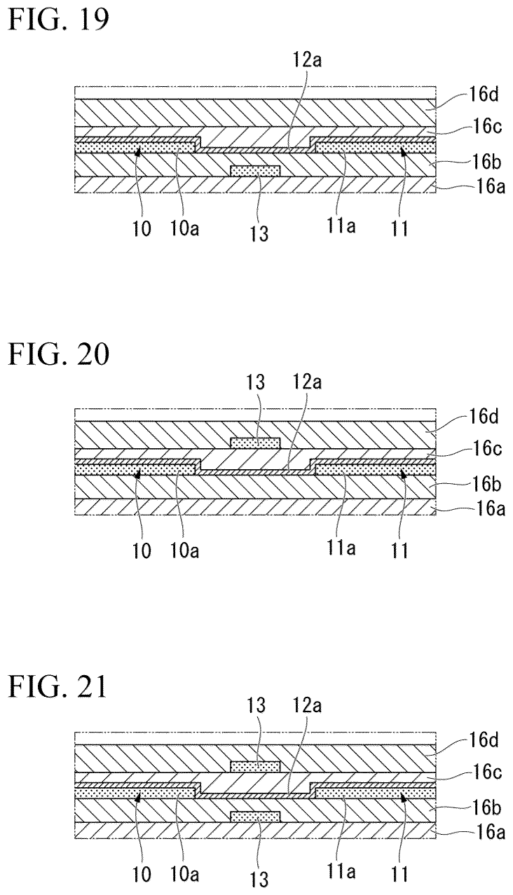

In the first example embodiment, the configuration in which the third electrode 13 is located below the carbon nanotube film 12a as shown in FIG. 19 has been described.

For example, as shown in FIG. 20, the third electrode 13 may be disposed above the carbon nanotube film 12a. In this case, the third electrode 13 can be disposed, for example, between the first upper protective film 16c and the second upper protective film 16d.

Moreover, as shown in FIG. 21, the third electrode 13 may be disposed both above and below the carbon nanotube film 12a. In other words, the bolometer 2 may include a plurality of third electrodes 13 arranged in the vertical direction with the carbon nanotube film 12a sandwiched therebetween.

By disposing the third electrodes 13 both above and below carbon nanotube film 12a, the electric field strength of the electric field applied to carbon nanotube film 12a becomes stronger than in a case where only one third electrode 13 is provided.

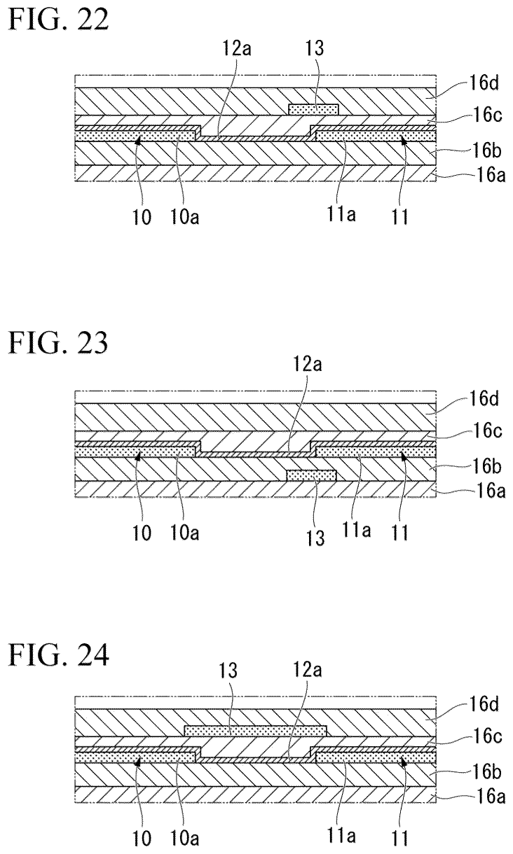

Furthermore, as shown in FIG. 22, the third electrode 13 may be disposed so as to partially overlap the second base end 11a of the second electrode 11 in a case where viewed from above. By positioning the third electrode 13 so that it overlaps with the second electrode 11 in a case where viewed from above, the distance between the third electrode 13 and the second electrode 11 becomes shorter than in a case where the third electrode 13 is positioned at the center position between the first base end 10a of the first electrode 10 and the second base end 11a of the second electrode 11. Therefore, according to the configuration shown in FIG. 22, the electric field strength of the electric field applied to the carbon nanotube film 12a becomes strong.

As shown in FIG. 22, the third electrode 13 may be disposed above the carbon nanotube film 12a. The third electrode 13 may be disposed below the carbon nanotube film 12a.

Moreover, the third electrode 13 may be disposed so as to partially overlap the first base end 10a of the first electrode 10 in a case where viewed from above.

Furthermore, as shown in FIG. 23, the third electrode 13 may be disposed so as to entirely overlap the second base end 11a of the second electrode 11 in a case where viewed from above.

As shown in FIG. 23, the third electrode 13 may be disposed below the carbon nanotube film 12a. The third electrode 13 may be disposed above the carbon nanotube film 12a.

Furthermore, as shown in FIGS. 24 to 26, the third electrode 13 may be formed to have a length that reaches from the first base end 10a of the first electrode 10 to the second base end 11a of the second electrode 11 in a case where viewed from above. In such a case, the third electrode 13 overlaps both the first base end 10a of the first electrode 10 and the second base end 11a of the second electrode 11 in a case where viewed from above.

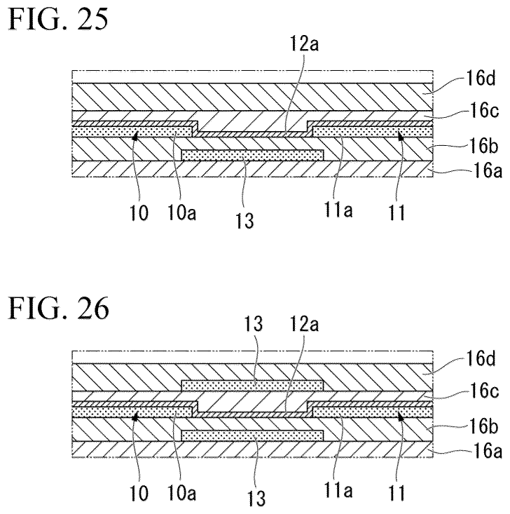

Therefore, according to the configuration shown in FIGS. 24 and 25, the electric field strength of the electric field applied to the carbon nanotube film 12a becomes strong.

As shown in FIG. 24, the third electrode 13 may be disposed above the carbon nanotube film 12a.

As shown in FIG. 25, the third electrode 13 may be disposed below the carbon nanotube film 12a.

Moreover, as shown in FIG. 26, the third electrode 13 may be disposed both above and below the carbon nanotube film 12a.

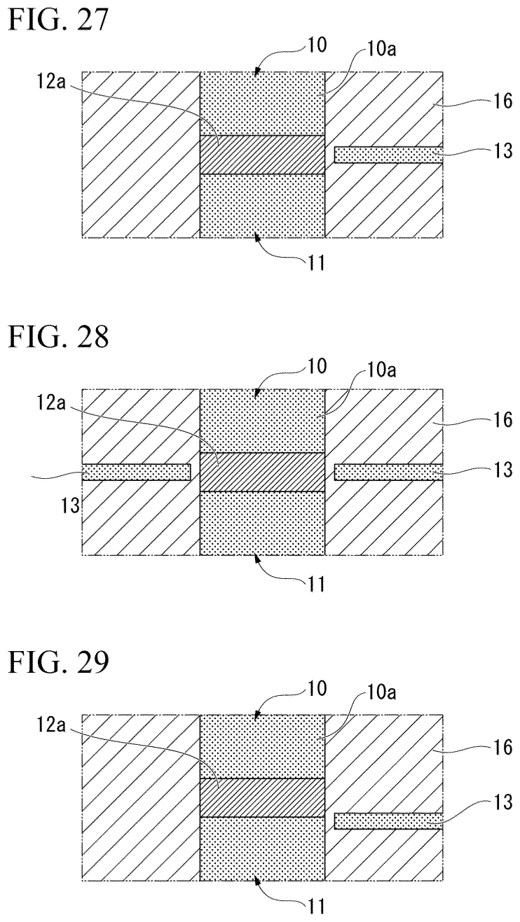

As shown in FIG. 27, the third electrode 13 may be disposed next to the carbon nanotube film 12a in the second direction.

In this manner, by arranging the third electrode 13 alongside the carbon nanotube film 12a in the second direction, the size of the bolometer 2 in the vertical direction can be reduced.

As shown in FIG. 28, the third electrode 13 may be disposed on both sides of the carbon nanotube film 12a in the second direction.

According to the configuration shown in FIG. 28, the electric field strength of the electric field applied to carbon nanotube film 12a is stronger than that in the configuration shown in FIG. 27 in which only one third electrode 13 is provided.

As shown in FIG. 29, the third electrode 13 may be disposed close to the second base end 11a of the second electrode 11.

According to the configuration shown in FIG. 29, the electric field strength of the electric field applied to the carbon nanotube film 12a is stronger than in a case where the third electrode 13 is positioned at the center position between the first base end 10a of the first electrode 10 and the second base end 11a of the second electrode 11.

The third electrode may be disposed closer to the first base end 10a of the first electrode 10.

Also, as shown in FIG. 30, the third electrode 13 may be arranged on both sides of the carbon nanotube film 12a in the second direction, being positioned close to the first base end 10a of the first electrode 10 and the second base end 11a of the second electrode 11, respectively.

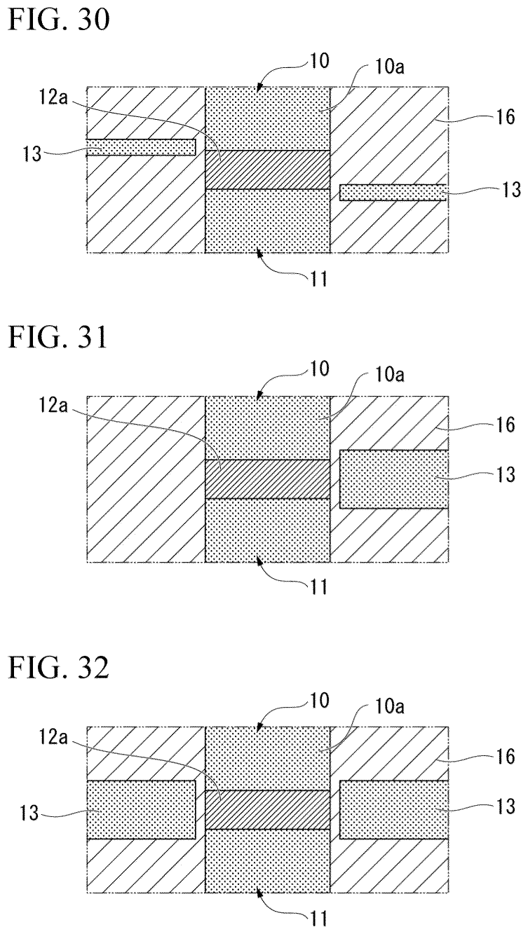

Also, as shown in FIG. 31, the width of the third electrode 13 in a direction (first direction) perpendicular to the second direction may be greater than the distance between the first base end 10a of the first electrode 10 and the second base end 11a of the second electrode 11 (the width of the inter-electrode region 18).

According to the configuration shown in FIG. 31, the electric field strength of the electric field applied to the carbon nanotube film 12a is stronger than that of the configuration shown in FIG. 27, because the electric field is closer to both the first base end 10a of the first electrode 10 and the second base end 11a of the second electrode 11.

As shown in FIG. 32, the third electrode 13 may be disposed on both sides of the carbon nanotube film 12a in the second direction.

### Second Example Embodiment

A second example embodiment of a bolometer array and a light detection method according to the present disclosure will be described below.

In the description of the present example embodiment, the description of the same parts as those in the first example embodiment will be omitted or simplified.

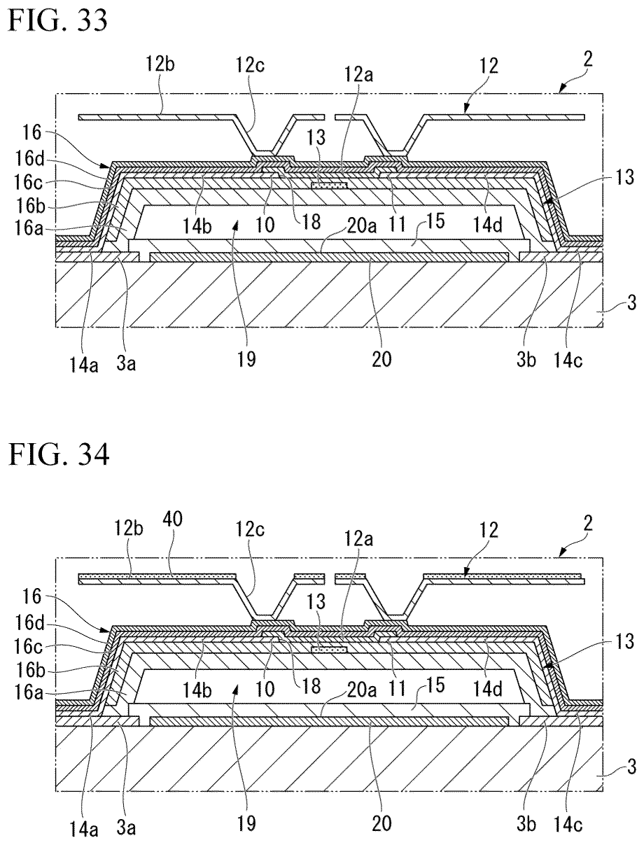

As shown in FIG. 33, the sensor portion 12 of the bolometer 2 may include a light receiving portion 12b and a connection portion 12c.

The light receiving portion 12b is a portion at the top of the bolometer 2, separated from the carbon nanotube film 12a, and extending like a roof above the carbon nanotube film 12a. The light receiving portion 12b covers at least a part of the surface (one surface of the substrate 3) on which the first electrode 10, the second electrode 11 and the carbon nanotube film 12a are provided.

For example, the light receiving portion 12b may be formed to a size that covers the first electrode 10, the second electrode 11, and the carbon nanotube film 12a in a case where viewed from above. Furthermore, the light receiving portion 12b may be formed to a size sufficient to cover the wiring portion 14 in addition to the first electrode 10, the second electrode 11, and the carbon nanotube film 12a in a case where viewed from above.

For example, the light receiving portion 12b is formed in a plate shape except for the portion where the connection portion 12c is located.

Furthermore, the light receiving portion 12b may be formed of a material, such as silicon nitride or titanium nitride, that has the function of converting the received infrared rays into heat.

The outer periphery of the light receiving portion 12b may be rectangular or square.

The light receiving portion 12b may have a through hole that penetrates in the vertical direction.

The connection portion 12c extends from the light receiving portion 12b toward the carbon nanotube film 12a.

The connection portion 12c supports the light receiving portion 12b above the first electrode 10, the second electrode 11, and the carbon nanotube film 12a.

The upper end of the connection portion 12c is thermally connected to the light receiving portion 12b.

The lower end of the connection portion 12c is in contact with the surface of the protective film 16, and is thereby thermally connected to carbon nanotube film 12a via the protective film 16. Furthermore, the connection portion 12c may be further thermally connected to the first electrode 10 and the second electrode 11 via the protective film 16.

Specifically, the lower end of the connection portion 12c may be in contact with a portion of the upper surface of the protective film 16 that is provided across the upper surface of carbon nanotube film 12a, the upper surface of first electrode 10, and the upper surface of second electrode 11.

For example, the connection portion 12c may have an upper surface that is recessed downward from the light receiving portion 12b and a lower surface that protrudes downward relative to the upper surface, thereby extending recessed toward the carbon nanotube film 12a.

For example, the connection portion 12c may be integrally formed from the same material as the light receiving portion 12b.

The bolometer 2 may be provided with a reflective film 20.

For example, the position of the light receiving portion 12b in the vertical direction may be a position where the distance from the reflective film 20 to the light receiving portion 12b is one-fourth of the target absorption wavelength.

The position of the light receiving portion 12b in the vertical direction may be such that the distance from the reflective film 20 to the light receiving portion 12b is an integer multiple of 2 or more of one-fourth of the target absorption wavelength.

The light receiving portion 12b may include a metal layer and two insulating layers sandwiching the metal layer in the vertical direction. In this case, for example, the distance from the reflective film 20 to the light receiving section 12b is preferably such that the distance from the upper surface 20a of the reflective film 20 to the lower surface of the metal layer is one-fourth of the target absorption wavelength.

In addition, the distance from the reflective film 20 to the light receiving portion 12b may be such that the distance from the upper surface 20a of the reflective film 20 to the lower surface of the metal layer is an integer multiple of 2 or more of one-fourth of the target absorption wavelength.

In a case where light to be detected is incident on the bolometer 2 of the present example embodiment, the light receiving portion 12b converts the light to be detected into heat.

The heat generated in the light receiving portion 12b is transmitted through the connection portion 12c and, via the protective film 16, heats the carbon nanotube film 12a.

In a case where the carbon nanotube film 12a is heated, the electrical resistance value of the carbon nanotube film 12a changes.

The bolometer 2 of the present example embodiment receives light to be detected by the light receiving portion 12b and converts it into heat. Therefore, even if the light receiving area inside the bolometer 2 of the present example embodiment is reduced by providing the third electrode 13, the bolometer 2 can ensure a wide light receiving area for the light to be detected.

Similarly, even if the inter-electrode region 18 has a meandering shape, a wide light receiving area for the light to be detected can be ensured.

### (Modification)

As shown in FIG. 34, the bolometer 2 may include an absorbing member 40 on the upper surface of the light receiving section 12b, which absorbs light in a wavelength band including the target absorption wavelength.

The absorbing member 40 may be, for example, a thin film member that utilizes plasmon absorption. Plasmon absorption is the effect of metal particles absorbing light of specific wavelengths.

For example, a thin film member whose absorption wavelength can be changed by controlling the structure of the patch antenna can be used as a thin film member that utilizes plasmon absorption.

Furthermore, a metal matching film, whose absorption wavelength can be changed by changing the thickness of the metal thin film, can be used as a thin film member that utilizes plasmon absorption.

Furthermore, a thin film member in which the absorption wavelength can be changed by graphene can be used as a thin film member that utilizes plasmon absorption.

### Third Example Embodiment

Hereinbelow, a bolometer array unit according to the present disclosure will be described as a third example embodiment.

In the description of the present example embodiment, the description of the same parts as those in the first example embodiment will be omitted or simplified.

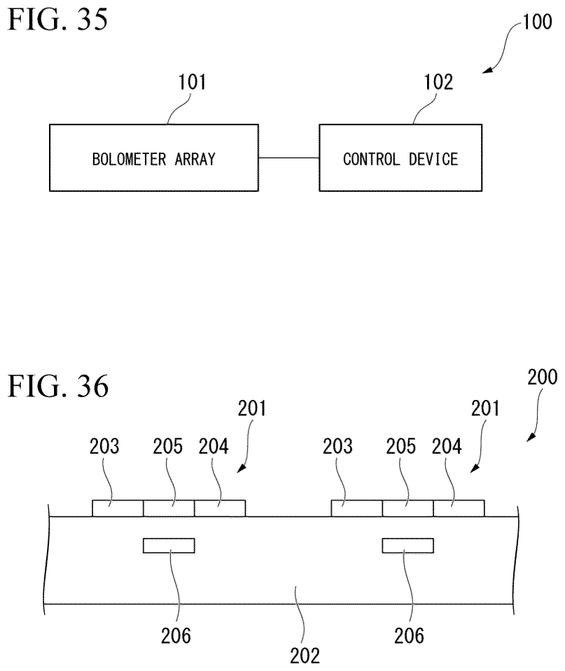

As shown in FIG. 35, the bolometer array unit 100 of the present example embodiment is provided with a bolometer array 101 and a control device 102.

The bolometer array 101 may be, for example, the bolometer array 1 described in the above example embodiment. However, the bolometer array 101 may be any bolometer array that includes the carbon nanotube film 12a and the third electrode 13.

The control device 102 is capable of adjusting the voltage applied to the third electrode 13 for each bolometer 2. For example, the control device 102 may store in advance, as a table, voltage values for making the characteristics of the bolometer 2 the reference characteristics. The control device 102 adjusts the voltage to be applied to the third electrode 13 for each bolometer 2 based on the stored table.

It should be noted that the characteristics of the bolometer 2 may change over time. For this reason, the control device 102 may perform a maintenance operation to obtain the characteristics of the bolometer 2.

The control device 102 may update the table using the characteristics of the bolometer 2 obtained during the maintenance operation.

### Fourth Example Embodiment

A fourth example embodiment of the bolometer array and light detection method according to the present disclosure will be described below.

As shown in FIG. 36, the bolometer array 200 includes a plurality of bolometers 201 and a substrate 202 on which the plurality of bolometers 201 are arranged side by side.

Each of the bolometers 201 includes a first electrode 203, a second electrode 204, a semiconducting carbon nanotube film 205, and a third electrode 206.

The second electrode 204 is provided with an inter-electrode region sandwiched between the first electrode 203 and the second electrode 204.

The semiconducting carbon nanotube film 205 is connected to the first electrode 203 and the second electrode 204.

The third electrode 206 is disposed apart from the semiconducting carbon nanotube film 205. Furthermore, the third electrode 206 can adjust the electric field applied to the semiconducting carbon nanotube film 205 in accordance with the characteristics of the semiconducting carbon nanotube film 205.

The photodetection method of the present example embodiment uses the bolometer array 200 to adjust the electric field applied to the semiconducting carbon nanotube film 205 in accordance with the characteristics of the semiconducting carbon nanotube film 205.

The bolometer array 200 and the light detection method of the present example embodiment are capable of adjusting the characteristics of the semiconducting carbon nanotube film 205, including the resistance value and the resistance temperature coefficient, by using the third electrode 206.

Therefore, the bolometer array 200 and the light detection method of the present example embodiment can suppress the influence on the detection performance due to the variation in characteristics of the bolometers 2, such as the resistance value and the resistance temperature change coefficient.

Although the example embodiment of the present disclosure has been described above, the present example embodiment is shown as an example and is not intended to limit the scope of the present disclosure. This example embodiment can be implemented in various other forms, and various omissions, substitutions, and modifications can be made without departing from the spirit of the present disclosure. Moreover, each example embodiment can be appropriately combined with other example embodiments.

According to the above example aspects, it is possible to suppress the influence on the detection performance due to the variation in characteristics such as the resistance value and the resistance temperature coefficient of the bolometer.

While preferred example embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

Some or all of the above-described example embodiments may be described as, without being limited to, the following supplementary notes.

### (Supplementary Note 1)

A bolometer array comprising:
a plurality of bolometers; and
a substrate on which the plurality of bolometers are arranged,
wherein each of the bolometers comprises:
a first electrode;
a second electrode provided across an inter-electrode region from the first electrode; and
a semiconducting carbon nanotube film connected to the first electrode and the second electrode; and
a third electrode that is disposed apart from the semiconducting carbon nanotube film and that is capable of adjusting an electric field applied to the semiconducting carbon nanotube film in accordance with the characteristics of the semiconducting carbon nanotube film.

### (Supplementary Note 2)

The bolometer array according to Supplementary Note 1, wherein each of the bolometers comprises:
support legs that support the first electrode, the second electrode, and the semiconducting carbon nanotube film so that a cavity is formed between them and the substrate,
the support legs including:
a first support leg including a first wiring connected to the first electrode;
a second support leg including a second wiring connected to the second electrode; and
a third support leg including a third wiring connected to the third electrode.

### (Supplementary Note 3)

A bolometer array as described in Supplementary Note 2, wherein each of the bolometers has a fourth support leg that does not include wiring as the support leg.

### (Supplementary Note 4)

The bolometer array according to Supplementary Note 3, wherein the bolometers are arranged in a first direction and a second direction perpendicular to the first direction; and

when viewed from a third direction perpendicular to the first direction and the second direction, the first support leg and the second support leg are arranged in the first direction with the semiconducting carbon nanotube film therebetween, and the third support leg and the fourth support leg are arranged in the second direction with the semiconducting carbon nanotube film therebetween.

### (Supplementary Note 5)

The bolometer array according to any one of supplementary notes 1 to 4, wherein the bolometers are arranged in a first direction and a second direction perpendicular to the first direction; and

when viewed from a third direction perpendicular to the first direction and the second direction, the third electrode is disposed so as to at least partially overlap the semiconducting carbon nanotube film.

### (Supplementary Note 6)

The bolometer array according to Supplementary Note 5, wherein when viewed from the third direction, the third electrode is disposed so as to at least partially overlap at least one of the first electrode and the second electrode.

### (Supplementary Note 7)

The bolometer array according to Supplementary Note 5 or 6, wherein each of the bolometers comprises a plurality of the third electrodes arranged in the third direction with the semiconducting carbon nanotube film therebetween.

### (Supplementary Note 8)

The bolometer array according to any one of supplementary notes 1 to 4, wherein the bolometers are arranged in a first direction and a second direction perpendicular to the first direction; and
the first electrode and the second electrode are arranged in the first direction with the semiconducting carbon nanotube film therebetween; and
the third electrode is disposed alongside the semiconducting carbon nanotube film in the second direction.

### (Supplementary Note 9)

The bolometer array according to Supplementary Note 8, wherein in the first direction, the width of the third electrode is larger than an inter-electrode distance between the first electrode and the second electrode.

### (Supplementary Note 10)

A bolometer array unit comprising:
the bolometer array according to any one of supplementary notes 1 to 9; and
a control device capable of adjusting a voltage to be applied to the third electrode for each of the bolometers.

### (Supplementary Note 11)

A light detection method, wherein in a bolometer array comprising a first bolometer and a second bolometer as bolometers, each of which comprises:
a first electrode;
a second electrode provided across an inter-electrode region from the first electrode; and
a semiconducting carbon nanotube film connected to the first electrode and the second electrode,
the method adjusts the electric field applied to the semiconducting carbon nanotube film according to the characteristics of the semiconducting carbon nanotube film.

### (Supplementary Note 12)

The light detection method according to Supplementary Note 11,

wherein each of the bolometers is provided with a third electrode that is disposed apart from the semiconducting carbon nanotube film and that is capable of adjusting an electric field applied to the semiconducting carbon nanotube film in accordance with characteristics of the semiconducting carbon nanotube film.

### (Supplementary Note 13)

The light detection method according to Supplementary Note 12, wherein each of the bolometers comprises:
support legs that support the first electrode, the second electrode, and the semiconducting carbon nanotube film so that a cavity is formed between them and a substrate,
the support legs comprising:
a first support leg including a first wiring connected to the first electrode;
a second support leg including a second wiring connected to the second electrode; and
a third support leg including a third wiring connected to the third electrode.

### (Supplementary Note 14)

The light detection method according to Supplementary Note 13, wherein each of the bolometers has a fourth support leg that does not include wiring as the support leg.

### (Supplementary Note 15)

The light detection method according to Supplementary Note 14,
wherein the bolometers are arranged in a first direction and a second direction perpendicular to the first direction; and
when viewed from a third direction perpendicular to the first direction and the second direction, the first support leg and the second support leg are arranged in the first direction with the semiconducting carbon nanotube film therebetween, and the third support leg and the fourth support leg are arranged in the second direction with the semiconducting carbon nanotube film therebetween.

### (Supplementary Note 16)

The light detection method according to any one of supplementary notes 12 to 15,
wherein the bolometers are arranged in a first direction and a second direction perpendicular to the first direction; and
when viewed from a third direction perpendicular to the first direction and the second direction, the third electrode is disposed so as to at least partially overlap the semiconducting carbon nanotube film.

### (Supplementary Note 17)

The bolometer array according to Supplementary Note 16, wherein when viewed from the third direction, the third electrode is disposed so as to at least partially overlap at least one of the first electrode and the second electrode.

### (Supplementary Note 18)

The bolometer array according to Supplementary Note 16 or 17, wherein each of the bolometers comprises a plurality of the third electrodes arranged in the third direction with the semiconducting carbon nanotube film therebetween.

### (Supplementary Note 19)

The light detection method according to any one of supplementary notes 12 to 15,
wherein the bolometers are arranged in a first direction and a second direction perpendicular to the first direction; and
the first electrode and the second electrode are arranged in the first direction with the semiconducting carbon nanotube film therebetween; and
the third electrode is disposed alongside the semiconducting carbon nanotube film in the second direction.

### (Supplementary Note 20)

The light detection method according to Supplementary Note 19,

wherein in the first direction, the width of the third electrode is larger than an inter-electrode distance between the first electrode and the second electrode.

### (Supplementary Note 21)

The light detection method according to any one of supplementary notes 12 to 20, adjusting a voltage applied to the third electrode for each of the bolometers.

What is claimed is:

1. A bolometer array comprising:
a plurality of bolometers; and
a substrate on which the bolometers are arranged,
wherein each of the bolometers comprises:
a first electrode;
a second electrode, wherein the first electrode and the second electrode are provided with an inter-electrode region therebetween;
a semiconducting carbon nanotube film connected to the first electrode and the second electrode; and
a third electrode that is disposed apart from the semiconducting carbon nanotube film and that is capable of adjusting an electric field applied to the semiconducting carbon nanotube film in accordance with characteristic of the semiconducting carbon nanotube film.

2. The bolometer array according to claim 1,
wherein each of the bolometers comprises:
support legs that support the first electrode, the second electrode, and the semiconducting carbon nanotube film so that a cavity is formed between them and the substrate,
the support legs comprises:
a first support leg including a first wiring connected to the first electrode;
a second support leg including a second wiring connected to the second electrode; and
a third support leg including a third wiring connected to the third electrode.

3. The bolometer array according to claim 2, wherein each of the bolometers has a fourth support leg that does not include wiring as the support leg.

4. The bolometer array according to claim 3,
wherein the bolometers are arranged in a first direction and a second direction perpendicular to the first direction; and
when viewed from a third direction perpendicular to the first direction and the second direction, the first support leg and the second support leg are arranged in the first direction with the semiconducting carbon nanotube film therebetween, and the third support leg and the fourth support leg are arranged in the second direction with the semiconducting carbon nanotube film therebetween.

5. The bolometer array according to claim 1,
wherein the bolometers are arranged in a first direction and a second direction perpendicular to the first direction; and
when viewed from a third direction perpendicular to the first direction and the second direction, the third electrode is disposed so as to at least partially overlap the semiconducting carbon nanotube film.

6. The bolometer array according to claim 5, wherein when viewed from the third direction, the third electrode is disposed so as to at least partially overlap at least one of the first electrode or the second electrode.

7. The bolometer array according to claim 5, wherein each of the bolometers comprises a plurality of the third electrodes arranged in the third direction with the semiconducting carbon nanotube film therebetween.

8. The bolometer array according to claim 1,
wherein the bolometers are arranged in a first direction and a second direction perpendicular to the first direction; and
the first electrode and the second electrode are arranged in the first direction with the semiconducting carbon nanotube film therebetween; and
the third electrode is disposed alongside the semiconducting carbon nanotube film in the second direction.

9. A bolometer array unit comprising:
the bolometer array according to claim 1; and
a control device configured to adjust a voltage to be applied to the third electrode for each of the bolometers.

10. A light detection method, wherein in a bolometer array comprising a first bolometer and a second bolometer as bolometers, each of which comprises:
a first electrode;
a second electrode, wherein the first electrode and the second electrode are provided with an inter-electrode region therebetween; and
a semiconducting carbon nanotube film connected to the first electrode and the second electrode,
the method adjusts the electric field applied to the semiconducting carbon nanotube film according to characteristic of the semiconducting carbon nanotube film.
